(19) United States
(12) Patent Application Publication
(10) Pub. No.: US 2011/0320492 A1
(43) Pub. Date: Dec. 29, 2011

(54) SYSTEM AND METHOD FOR TRACKING VEHICLE OPERATION THROUGH USER-GENERATED DRIVING INCIDENT REPORTS

(75) Inventor: Philip INGHELBRECHT, San Francisco, CA (US)

(73) Assignee: DriveMeCrazy, Inc., San Francisco, CA (US)

(21) Appl. No.: 13/168,786

(22) Filed: Jun. 24, 2011

Related U.S. Application Data
(60) Provisional application No. 61/398,395, filed on Jun. 24, 2010.

(51) Int. Cl. G06F 17/30

(52) U.S. Cl. 707/776; 707/E17.014

(57) ABSTRACT

A method and system that allows anyone to flag good or bad driving incidents by fellow motorists. Driving behavior data is captured as user-generated content, and the system includes the necessary provision to verify the authenticity and accuracy of all records submitted. The database of driving records is subsequently used to calculate a driver risk-score, allowing companies to make informed decisions related to their business when impacted by driver behavior (e.g. calculating a car insurance premium).

### RELATED APPLICATIONS

This application claims priority to U.S. Provisional Patent Application No. 61/398,395, entitled “System and Method for Collection and Processing of User-Generated Content Regarding Drivers,” and filed Jun. 24, 2010, which is hereby incorporated by reference in its entirety into the present application.

### FIELD

The disclosure relates to tracking vehicle operation through user-generated driving incident reports, and mining the reports to determine information related to specific sets of one or more vehicles and/or vehicle operators.

### BACKGROUND

Car insurance companies gather enormous amounts of data in an attempt to correctly assess the risk associated with each driver. This is, however, not without challenges:

Limited sources of driving behavior data. State DMVs have an unintended, quasi-monopoly on the driver behavior data that is gathered by police enforcement. Currently, there is no other similar data available to insurance companies (e.g. ZIP, age, mileage, etc.) that can effectively measure an individual's driving behavior and/or performance.

Motor Vehicle Reports are poor indicators of future accidents. The average American sustains only one accident every 10 years. Less than 15% of all drivers have traffic violations on their record at any point in time (since records are cleared after three years). Furthermore, many small accidents go unreported and hit & runs occur frequently (e.g. a scratched vehicle in the parking lot). The low data density (i.e. not every driver has a report) that results from these rare incidents means that insurance companies would greatly benefit from additional sources of driving behavior in order to predict future accidents.

High reliance on non-driving data. Insurance companies use various other types of data to predict the risk associated with a driver, e.g. vehicle make and model, age, credit score, past accidents and claims, marital status, average annual mileage etc. Reliance on these types of data is another indication of how desperate insurance companies are for better data that predicts driving performance.

The net effect of this data scarcity is market information asymmetry. This is costly to both insurance companies and consumers:

Consumers. When individual driver data falls short, car insurance companies have no choice but to default to group-based premiums (e.g. based on education, ZIP code etc). While this approach provides statistical direction, it goes without saying that it imposes heavy sanctions on individuals who happen to fit the wrong profile (and vice versa).

Insurance companies. The scarcity of data means that many insurance companies are unable to accurately rate their customers. A study by ISO in January 2010 (“Auto Insurance Leaves Billions on the Table”) revealed that the premium leakage amounts to $15.9 billion annually. Insurance companies have little choice but to pass part of this cost through to the consumer (as evidenced by higher car insurance rates despite increased competition).

As such, there is a strong need in the market for more and better driving behavior data. Efforts to date have focused on increasing police patrol, staging driving awareness campaigns (e.g. click-it or ticket month), in-vehicle telematics (e.g. offered through Progressive MyRate), and road-side technology that automatically captures moving violations (e.g. red light cameras). However, none have truly leveraged the first or immediate observers of driving behavior i.e. the millions of daily fellow motorists with whom we share the road. A system that allows anyone to safely report good or bad driving behavior (whilst on the road) is without doubt the most comprehensive, direct, and continuous approach to assess a driver's behavior.

The benefits of such a system extend beyond collecting data. By making anyone's driving behavior and performance public, we expect people to drive more carefully, as if they were surrounded by unmarked police

### SUMMARY

One aspect of the disclosure relates to a system and method of obtaining, organizing, aggregating, valuing, and/or otherwise processing driving incident reports received from users. The driving incident reports may be received on computing platforms associated with the users (e.g., Smartphones, tablet platforms, onboard computer systems, and/or other platforms). The driving incident reports may be harvested on the computing platforms via an application or “app” that enables the users to enter a vehicle identifier (e.g., a license plate number) and/or information about a driving incident being reported in a simple and intuitive manner.

For example, a system may be configured to receive driving incident reports from users including vehicle identifiers spoken by users into their computing platforms. Information related to a driving incident reported may be selected from prepared menus or screens, and/or messages or additional descriptive information may be provided via text, speech, captured video and/or still images, or through other information gathering mechanisms.

The system may be configured to verify vehicle identifiers included in the driving incident reports using, for example, stored correlations between vehicle identifiers and vehicle description information. Such stored information may include, for example, previous driving incident reports, Department of Motor Vehicle records, and/or other stored information.

The driving incident reports may be authenticated using location information for reporting users and/or the vehicles which are the subjects of the driving incident reports (or their users), time information included in the driving incident reports, and/or other information. Historic information related to the reporting users and/or the subject vehicles may be used to further authenticate driving incident reports.

Driving incident reports may be aggregated across a common subject vehicle, across a common owner/operator of subject vehicles, and/or across other common characteristics. Aggregated reports may be generated based on these aggregations. The aggregated reports may provide an indication of vehicle operation history, driving safety, and/or other parameters.

These and other objects, features, and characteristics of the system and/or method disclosed herein, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of “a”, “an”, and “the” include plural referents unless the context clearly dictates otherwise.

### BRIEF DESCRIPTION OF THE DRAWINGS

FIG. 1 illustrates a method of organizing information related to vehicle operation.

FIG. 2 illustrates a method of processing driving incident reports.

FIG. 3 illustrates a method of searching driving incident reports.

FIG. 4 illustrates a method of organizing information related to vehicle operation.

FIG. 5 illustrates a system configured to organize information related to vehicle operation.

### DETAILED DESCRIPTION

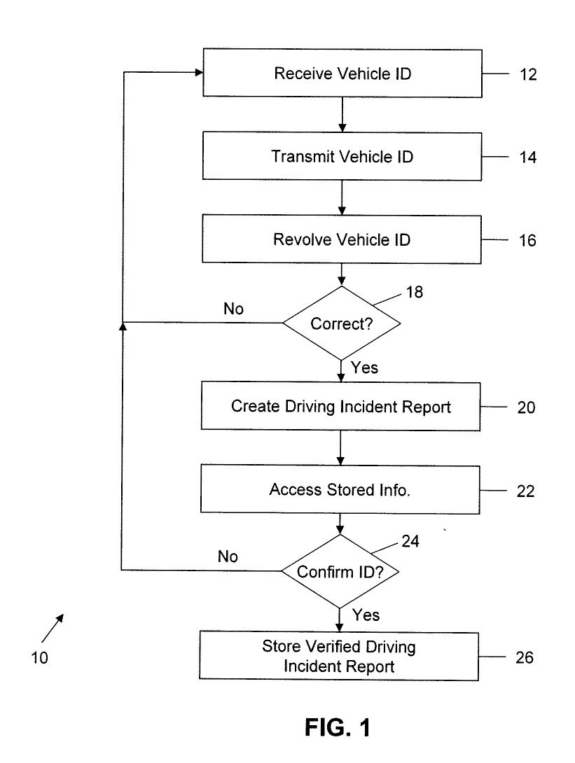

FIG. 1 illustrates a method 10 of organizing information related to vehicle operation. The operations of method 10 presented below are intended to be illustrative. In some embodiments, method 10 may be accomplished with one or more additional operations not described, and/or without one or more of the operations discussed. Additionally, the order in which the operations of method 10 are illustrated in FIG. 1 and described below is not intended to be limiting.

In some embodiments, method 10 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 10 in response to instructions stored electronically on an electronic storage medium. The one or more processing devices may include one or more devices configured through hardware, firmware, and/or software to be specifically designed for execution of one or more of the operations of method 10.

At an operation 12, a driving incident report may be received. The driving incident report may be a preliminary driving incident report. The preliminary driving incident report may be received from a user. The driving incident report may be received via a computing platform associated with the user. Such a computing platform may include, for example, a smartphone, a laptop computer, a desktop computer, an onboard computing platform included in a vehicle, a tablet computing platform, a NetBook, and/or other computing platforms. The driving incident report may include a vehicle identifier associated with a vehicle. The vehicle may be subject vehicle (e.g., the vehicle being reported in the preliminary vehicle incident report). The vehicle identifier may include one or more of a license plate number, a vehicle fleet number, and/or other vehicle identifiers. The preliminary driving incident report received at operation 12 may include audio information (e.g., spoken by the user in a hands-free manner, and/or other audio information), textual information, video information, still image information, and/or other information.

At an operation 14, information included in the preliminary driving incident report may be transmitted to a server remote from the user. This transmission may be made via a wireless network, and/or other networks or communication techniques. At operation 14, the preliminary driving incident report, and/or information associated therewith may be received by the server.

At an operation 16, the information included in the preliminary driving incident report may be deciphered to resolve the vehicle identifier included in the preliminary driving incident report. This may include a speech-to-text recognition process, a video or image interpretation process, a handwriting analysis, and/or other process for deciphering information in the preliminary driving incident report. At operation 16, the resolved vehicle identifier may be transmitted to the user. This may include transmitting the resolved vehicle identifier to the computing platform used by the user to input the preliminary driving incident report.

At an operation 18, a determination may be made as to whether the vehicle identifier resolved from the preliminary driving incident report is correct. Such a determination may be made based on user input (e.g., in response to display of the resolved vehicle identifier). Such input may be received via the computing platform associated with the user. Input received at the computing platform may be transmitted to the server at operation 18. The determination made at operation 18 may be made at the computing platform and/or the server. Responsive to the resolved vehicle identifier being incorrect, method 10 may return to operation 12. Responsive to the resolved vehicle identifier being correct, method 10 may pass to an operation 20.

At operation 20, the preliminary driving incident report may be implemented to create a driving incident report. The driving incident report may include the vehicle identifier and other report information. The report information may include information determined automatically and/or information entered manually by the user. Information entered manually by the user may have been included in the preliminary driving incident report received at operation 12, and/or information entered manually by the user subsequent to confirming the resolved vehicle identifier. The report information may include one or more of a reporting identifier of the reporting user (e.g., username, license plate number, legal name, and/or other identifiers), time, date, location, subject driver identification and/or description (e.g., male, female, and/or other descriptive information), subject vehicle description (e.g., vehicle/body type, make, model, year, and/or other information), and/or other information. The report information may include a driving incident type (e.g., speeding, driving aggressively, changing lanes unsafely, driving too slow, operating phone while driving, courteous behavior, attentive or helpful driving, and/or other incident types), a description of the driving incident, a message for the driver of the subject vehicle, photos, videos, and/or other information.

At an operation 22, vehicle information related to the subject vehicle and/or its driver may be accessed from electronic storage. The electronic storage may be accessible to the server. The information may include information that can be used to verify the accuracy of the resolved vehicle identifier. For example, the vehicle information may include a make, model, year of manufacture, and/or other information associated with the vehicle to which the resolved vehicle identifier corresponds. The electronic storage accessed at operation 22 may include, for example, Department of Motor Vehicles registration information, private vehicle identifier databases (e.g., fleet records, oil change facilities, and/or other databases), previous driving incident reports involving the subject vehicle, and/or other sources of information for the subject vehicle.

At an operation 24, the vehicle information accessed at operation 22 may be implemented to confirm the resolved vehicle identifier. This may include comparing vehicle information included in the driving incident report by the reporting user with the accessed vehicle information, presenting the accessed vehicle information to the reporting user for confirmation (e.g., “Did you mean a 2006 Toyota Camry?”), and/or other forms of confirmation. Responsive to the accessed vehicle information not matching the subject vehicle, method 10 may stop, return to operation 12, and/or proceed in some other manner. Responsive to the accessed vehicle information matching the subject vehicle at operation 24, method 10 may proceed to an operation 26.

At an operation 26, the driving incident report may be stored as a verified driving incident report. This may include creating an electronic record of the verified driving incident report in a database. The electronic record may include some or all of the information received/obtained/accessed/resolved at one or more of operations 12, 14, 16, 20, and/or 22.

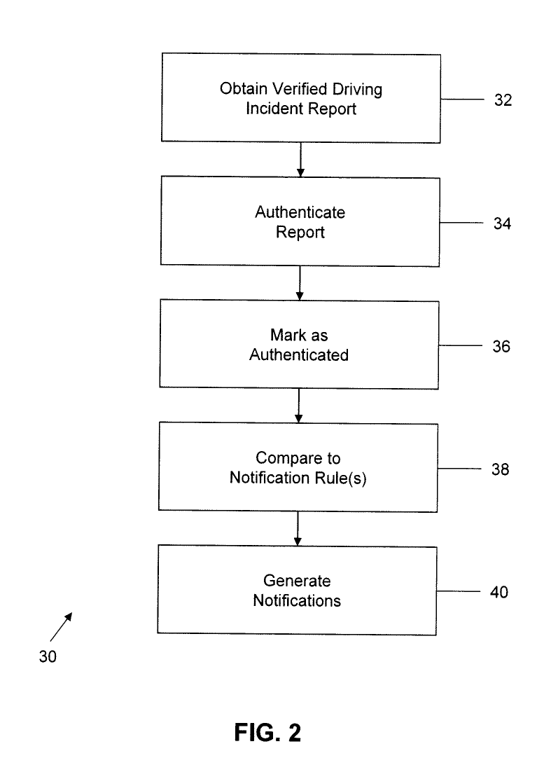

FIG. 2 illustrates a method 30 of processing driving incident reports. The operations of method 30 presented below are intended to be illustrative. In some embodiments, method 30 may be accomplished with one or more additional operations not described, and/or without one or more of the operations discussed. Additionally, the order in which the operations of method 30 are illustrated in FIG. 2 and described below is not intended to be limiting.

In some embodiments, method 30 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 30 in response to instructions stored electronically on an electronic storage medium. The one or more processing devices may include one or more devices configured through hardware, firmware, and/or software to be specifically designed for execution of one or more of the operations of method 30.

At an operation 32, a verified driving incident report may be obtained. The verified driving incident may memorialize a driving incident involving a subject vehicle. The verified driving incident report may have been created or initiated by a reporting user. In some implementations, the verified driving incident may have been generated in accordance with one or more of the operations described above with respect to method 10 (shown in FIG. 1). The verified driving incident report may include one or more of a vehicle identifier associated with the subject vehicle, a reporting identifier associated with the reporting user, a date, a time, a driving incident type, a driving incident description, a location of the driving incident (e.g., as reported by the reporting user, as determined based on geolocation information received automatically from a computing platform associated with the reporting user, with the subject vehicle, and/or with a driver of the subject vehicle), a message from the reporting user, vehicle information associated with the subject vehicle, and/or other information.

At an operation 34, the verified driving incident report may be further analyzed to determine reliability, to determine whether any notifications of the verified driving incident report should be sent, and/or for other purposes. The processing performed at operation 34 may be performed upon creation of the verified driving incident report, in batches of verified driving incident reports (e.g., performed periodically on previously un-processed reports), and/or at other times.

To determine reliability at operation 34, the verified driving report may be checked using day/time information, geographic location information, information about the reporting user, information about the subject vehicle, and/or other information. Verified driving incident reports that do not meet certain requirements along these parameters may be marked or flagged to denote their relative apparent unreliability (e.g., as “erroneous”).

By way of example, if the reporting user has previously reported the same subject vehicle in another driving incident report within a relatively short period of time (e.g., 5 min), then both driving incident reports may be counted as a single verified driving incident report.

As another non-limiting example, in some implementations, a subject vehicle can only be reported in driving incident reports a finite number of times (e.g., two) over a certain period of time (e.g., six months) by the same reporting user. The system also searches for reporting patterns across subject vehicles. Sudden spikes (e.g., 5 reports) within a period of time (e.g., a week) for a subject vehicle, preceded and followed by longer periods (e.g., one month) of no reports, may raise suspicion that certain reporting users (e.g., classmates) could be fraudulently reporting a particular vehicle. Responsive to the number of verified driving incident reports against the same subject vehicle exceeds the threshold levels defined above, then all verified driving incident reports against the subject vehicle, as reported by those reporting user(s), may be marked or flagged to denote their relative apparent unreliability.

As yet another non-limiting example, individual verified driving incident reports reported by a given reporting user may be checked against his or her full list of previous verified driving incident reports. It may be expected that there will be a natural dispersion with respect to time and vehicles reported. For example, and as explained above, if a reporting user has no activity and then suddenly reports the same subject vehicle a threshold number of times (e.g., 5) in a time period (e.g., 1 week), all of these driving incident reports originating from this reporting user may be marked or flagged to denote their relative apparent unreliability.

As still another non-limiting example, geo-location information may be included in the verified driving incident report. Such information may include, for example, a geolocation information (e.g., GPS information) obtained from the computing platform implemented by the reporting user to submit the driving incident report, stated location information in the driving incident report, geolocation information obtained automatically from a computing platform associated with the subject vehicle and/or its operator, and/or other geolocation information. The distance between two consecutive driving incident reports may be implemented to determine whether the subject vehicle can realistically have traveled that far (e.g. using a Google map APPLICATION PROGRAMMING INTERFACE, or via other mechanisms). For example, if a subject vehicle is included in a driving incident report by a reporting user in Chicago on Sun 2 pm PT, and then again in San Francisco on Sun 3 pm PT, then either or both of the driving incident reports may be in error since it takes at least 20 hours by car to travel between both locations, even at high speed. As a result one or both of the verified driving incident reports may be marked or flagged to denote their relative apparent unreliability.

As still another non-limiting example, geo-location and time information may also be used to ensure a reporting user does not spam the system by creating multiple incident reports by randomly submitting license plates of (different) vehicles parked in the same location. For example, if the reporting user flags four vehicles, with the time and distance between two consecutive flags less than 2 minutes and ⅛ mile respectively, all four incident reports may be marked or flagged to denote their relative apparent unreliability.

As a further non-limiting example, additional data may be requested as part of processing at operation 34. This additional data may be implemented for further confirmation of the verified driving incident report. For instance, at operation 34, the vehicle identifier in the verified driving incident report may be checked against a database of registered users. If the vehicle identifier of the subject vehicle corresponds to a registered user, then a computing platform associated with the registered user and/or the subject vehicle may be contacted with a request for location information. Such location information may include a current location, a previous location, and/or other location information. The request and/or the answer may be conducted automatically without intervention by the registered user, may require acceptance by the registered user, and/or may require the registered user to input or capture the location information. The location information received from this request may then compared to the geo location information included in the verified driving incident report. If significant discrepancies are noted or certain threshold distances are exceeded (such as the subject vehicle was not within a 1-mile radius of the location information in the verified driving incident report), then the verified driving incident report may be marked or flagged to denote their relative apparent unreliability. Such verification may provide an incentive to users for registering one or both of their computing platforms and/or vehicles to pro-actively and/or automatically manage potential malicious or erroneous driving incident reports, without the need for future corrections.

Operation 34 may include comparing the verified driving incident report with other sources of vehicle operation reports (e.g., StateFarm driving app, Progressive® Snapshot, and/or other sources). This comparison may include a comparison based on location, time, day, alleged infraction, and/or other parameters of the verified driving incident report. In some implementations, this comparison may be used at the weighting of driving incident reports (e.g., as discussed below), and/or not at operation 34.

Responsive to the verified driving incident report being determined at operation 34 as being accurate, the verified driving incident may be marked at an operation 36 as an authenticated driving incident report.

At an operation 38, the authenticated driving incident report may be compared with a set of one or more notification rules. A given notification rule may include one or more rule parameters, a report recipient, a report mechanism, and/or other aspects. A comparison of the authenticated driving incident report with the set of one or more notification rules may result in the identification of a notification rule having rule parameters that are satisfied by the authenticated driving incident report. Notification rules may be configured to entities or individuals to keep them notified of driving incident reports in which they have an interest. For example, to locate a stolen car, a notification rule may be created with rule parameters that are satisfied by a driving incident report including a vehicle identifier associated with the stolen car. As another non-limiting example, a parent or employer may create a rule with rule parameters that are satisfied by a driving incident report including a vehicle identifier associated with a vehicle operated by a dependent or employee. The notification recipient of a notification rule may include a user associated with the identified vehicle in a driving incident report. This may notify the driver of his own good or bad driving incident.

As still another non-limiting example of notification recipient, one or more other interested parties (e.g., an insurance company, a vehicle rental or leasing company, and/or other parties) may be listed as notification recipients. Providing notifications to such parties may facilitate such parties to track operation of a vehicle in which they have an interest. Such parties, upon receiving a notification, may forward the notification and/or information derived therefrom, to an operator of the subject vehicle. This may enable an operator of the subject vehicle that does not have a registered account to still receive information about notifications received regarding his operation of the subject vehicle.

As a further non-limiting example of a notification recipient, a law enforcement officer or agency may establish rules that result in notifications for a series of driving incident reports on an individual vehicle (e.g., over some threshold number) during some period of time indicating that a vehicle is being operated recklessly. Similarly, rules may be established to result in notifications to law enforcement for specific incident types (e.g., illegal parking, accident, and/or other incident types). Such rules may include location (e.g., without some geographic area) as a further parameter for filtering unrelated incident reports (e.g., to only provide notifications proximate to an officer and/or agency). The information provided with the notification to the law enforcement agency and/or officer may include information obtained from the subject vehicle (and/or user associated therewith), such as location information and/or likely direction (e.g., from GPS requests to a mobile device associated with the subject vehicle), to further facilitate law enforcement decision-making and/or function. Responsive to law enforcement agency or officer taking action based on a notification, the reporting user may receive an indication of subject action. The indication may be transmitted electronically to the reporting user. The action taken by the law enforcement agency or officer may include one or more of viewing the driving incident report associated with the notification, checking a record of the subject vehicle, travelling to the location associated with the driving incident report, writing a citation and/or taking other action against the subject vehicle and/or its operator, and/or other actions.

The notification recipient may not be a specific individual or entity. For example, The notification recipients of a rule may include other drivers in the vicinity of a driving incident report (as revealed by their geo-location). This may be useful, for example, if the identified vehicle is driving badly or aggressively, justifying a warning, such as a drunk driver alert.

At an operation 40, responsive to the authenticated driving incident report satisfying the rule parameters of a notification rule, a notification may be transmitted to the notification recipient of the notification rule. The notification may be transmitted according to the notification mechanism (e.g., email, phone call, SMS, other electronic message, and/or the mechanisms) indicated in the notification rule.

It will be appreciated that the illustration of operations 38 and 40 as occurring subsequent to operations 32, 34, and 36 is not intended to be limiting. Notifications based on driving incident reports may be generated (e.g., as disclosed) prior to processing the driving incident reports at operation 34, or even as part of method 10 (shown in FIG. 1).

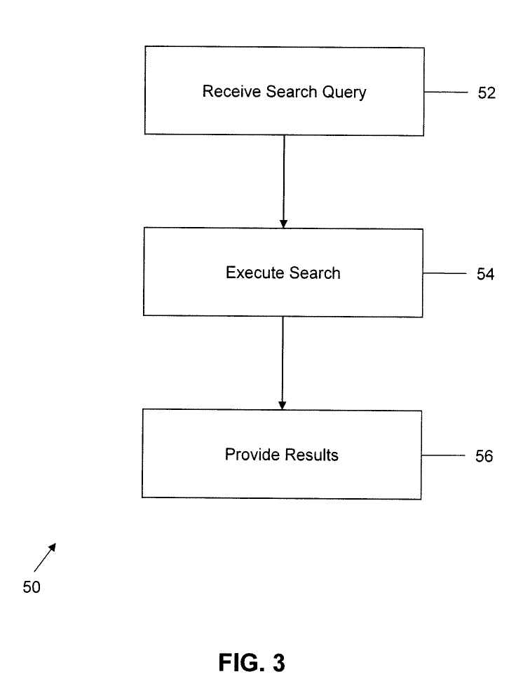

FIG. 3 illustrates a method 50 of searching driving incident reports. The driving incident reports may memorialize driving incidents reported by users. For example, the driving incident reports may include driving incident reports generated by a method 10 and/or verified by method 30 (illustrated in FIGS. 1 and 2, respectively). The driving incident reports may include one or more of a subject vehicle, a vehicle identifier, a reporting user, location information, date and/or time information, incident type, message, subject driver identification and/or description, subject vehicle description, and/or other information. The operations of method 50 presented below are intended to be illustrative. In some embodiments, method 50 may be accomplished with one or more additional operations not described, and/or without one or more of the operations discussed. Additionally, the order in which the operations of method 50 are illustrated in FIG. 3 and described below is not intended to be limiting.

In some embodiments, method 50 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 50 in response to instructions stored electronically on an electronic storage medium. The one or more processing devices may include one or more devices configured through hardware, firmware, and/or software to be specifically designed for execution of one or more of the operations of method 50.

At an operation 52, a search query may be received. The search query may include search parameters. The search parameters may specify values for one or more of a subject vehicle, a vehicle identifier, a reporting user, location information, date and/or time information, incident type, message, subject driver identification and/or description, subject vehicle description, and/or other information. The search query may be received from a user via a computing platform associated with the user. The search query may be transmitted to a server, and/or may be processed (e.g., as described herein) on the computing platform associated with the user.

At an operation 54, the driving incident reports may be searched, and a set of search results may be obtained. The driving incident reports included in the search results may be the driving incident reports that satisfy the search parameters of the received search query. It will be appreciated that some of the search parameters may not map directly to the underlying driving incident reports.

At an operation 56, the search results may be provided. The search results may be provided, for example, on the computing platform from which the search query was received. This may include transmitting the search results from the server to the computing platform for presentation to the user.

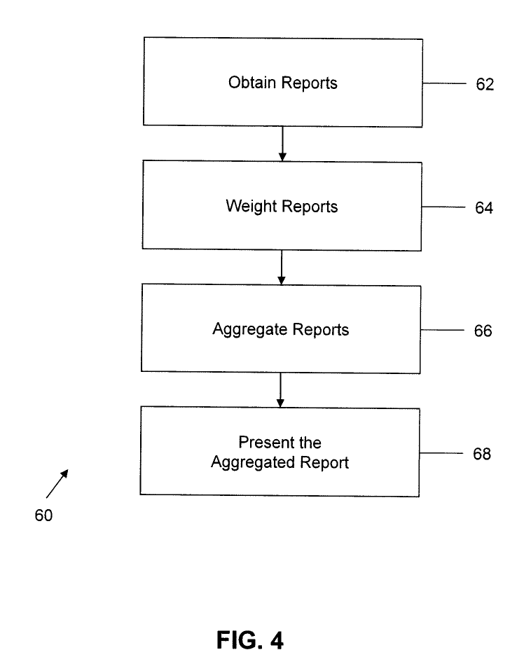

FIG. 4 illustrates a method 60 organizing information related to operation of vehicles. Using driving incident reports, one or more aggregated reports may be generated. The driving incident reports may include one or more of a subject vehicle, a vehicle identifier, a reporting user, location information, date and/or time information, incident type, message, subject driver identification and/or description, subject vehicle description, photo, video and/or other information. The driving incident reports may be aggregated to provide in-depth information on the history of a vehicle and/or a driver. The operations of method 60 presented below are intended to be illustrative. In some embodiments, method 60 may be accomplished with one or more additional operations not described, and/or without one or more of the operations discussed. Additionally, the order in which the operations of method 60 are illustrated in FIG. 4 and described below is not intended to be limiting.

In some embodiments, method 60 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 60 in response to instructions stored electronically on an electronic storage medium. The one or more processing devices may include one or more devices configured through hardware, firmware, and/or software to be specifically designed for execution of one or more of the operations of method 60.

At an operation 62, driving incident reports may be obtained. The driving incident reports may memorialize driving incidents involving subject vehicles. The driving incident reports may have been created or initiated by reporting users. In some implementations, the driving incident reports may have been generated in accordance with one or more of the operations described above with respect to methods 10 and/or 30 (shown in FIGS. 1 and 2, respectively). A given verified driving incident report may include one or more of a vehicle identifier associated with the subject vehicle, a reporting identifier associated with the reporting user, a date, a time, a driving incident type, a driving incident description, a location of the driving incident (e.g., as reported by the reporting user, as determined based on geolocation information received automatically from a computing platform associated with the reporting user, with the subject vehicle, and/or with a driver of the subject vehicle), a message from the reporting user, photo, video, vehicle information associated with the subject vehicle, and/or other information.

At an operation 64, individual driving incident reports aggregated at operation 62 may be assigned a weight. The weight assigned at operation 64 may represent a significance, a likelihood of occurrence, an importance, and/or other aspects. For example, driving incident reports less likely to be accurate may be assigned a lower weight than driving incident reports more likely to be accurate. Driving incident reports that are more significant and/or important may be assigned a higher weight than driving incident report that are less significant and/or important. Below are several not limiting examples of the manner in which driving incident reports may be weighted. It will be appreciated that the weight assigned to any single driving incident report may be a function of more than one consideration (e.g., based on likelihood of accuracy and on timeliness).

Severity of the driving incident reported in a driving incident report may impact the weight assigned to a driving incident report. When a reporting user submits detail with the driving incident report, such as incident type, that information may be used to give the driving incident report a greater or lesser rating. For example, running a red light may carry a higher (e.g., 200%) weight, whereas illegal parking may carry a lower (e.g., 20% weight). The weights may be set by allocating a percentage of severity to each incident (e.g., incident type), as revealed through the information submitted with a driving incident report. Any driving incident report without further significant information may carry a neutral 100% weight.

Date of the driving incident report may impact the weight assigned to a driving incident report. Recent driving incident reports may have greater weight (e.g. 150%) than older driving incident reports. The weight of a driving incident report could simply be depreciated down each month to zero over a 5-year horizon. As such, crossing a double yellow line last month may weigh twice as much as the same incident if it happened 2.5 years ago.

Repetition of one or more common parameters of driving incident reports for a driver or vehicle (e.g., incident type, location, time, day of the week, and/or other parameters). For example, if the same type of incident (e.g. speeding) accounts for half or more of all driving incident reports, then a higher weight may provided to this type of driving incident report (e.g. 150%), corresponding to their higher likelihood of accuracy.

Location of a driving incident report may impact the weight it is assigned. Driving incident reports reported in highly populated or traffic dense areas may have a higher weight than driving incident reports in rural areas. For example, a positive driving incident report (e.g., for courteous driving) in New York's Manhattan may be assigned a 150% weight compared to a reckless driving incident report in Victorville, Calif. which gets a 50% weight.

Availability of geo-information may impact the weight assigned to a driving incident report. Not all driving incident reports will carry information about the location (e.g. the smartphone had no GPS built-in, lack of GPS reception, and/or other factors). Driving incident reports without geo-information may carry less weight (e.g. 75%)

Verification of the vehicle when flagged may impact the weight assigned to a driving incident report. As explained above, some driving incident reports may be authenticated using geo-location information obtained from a computing platform associated with the subject vehicle and/or its driver. Driving incident reports on subject vehicles for which authentication is not possible may be given less weight (e.g. 50%).

Weights can be changed at anytime and the ones above are only provided indicatively. It should also be noted that calculated values can be either negative or positive. For example, operation 64 may factor in both negative driving incident reports and positive driving incident reports. The sign (e.g., + or −) of the weight assigned to driving incident reports may be opposite for these two different types of driving incident report. By way of non-limiting illustration, Table (1) below provides a purely exemplary listing of driving incident reports and calculated weights.

(1)

| Flag | Severity | Date | Frequency | Location | Geo-data | Verification | Weighted value |
|---|---|---|---|---|---|---|---|
| Red light violation - this month in NY | 200% | 150% | 150% | 150% | 100% | 50% | −3.38 |
| Red light violation - 3 years ago in AK | 200% | 60% | 150% | 30% | 75% | 100% | −0.41 |
| Illegal parking - 1 year ago in MI | 20% | 110% | 100% | 100% | 100% | 100% | −0.22 |
| Stopped for pedestrian - 2 months ago in PA | 150% | 145% | 100% | 120% | 100% | 100% | −2.61 |
| | | | | | | | 1.39 |

At an operation 66, driving incident reports may be aggregated. This aggregation may be based on vehicle identifier. This aggregation may be performed to aggregate driving incident reports common to a specific vehicle, to aggregate driving incident reports common to a driver, to aggregate reports of a type of vehicle (e.g., common make and/or model, common body type, and/or other types of vehicles), to aggregate reports in a geographical area, and/or other aggregations.

At times, the vehicle identifier associated with a given vehicle may change. For example, at a change of ownership, at periodic intervals (e.g., 7 years in Minnesota), and/or at other events, a license plate number of a vehicle may change. Aggregation of reports at operation 62 may account for such changes such that responsive to a vehicle identifier for a specific vehicle having changed from a first vehicle identifier to a second vehicle identifier, the aggregation of repots at operation 62 for the specific vehicle may include driving incident reports associated with the first vehicle identifier and the second vehicle identifier. This may be performed, for example, by linking the vehicle identifier included in the driving incident reports with a more permanent identifier, such as VIN number. By periodically (e.g. monthly) checking the registration records of a VIN through the relevant Department of Motor Vehicle, it may be determined whether the vehicle identifier has changed

For example, if the license plate changes (and owner remains the same), then the vehicle record for the VIN remains, and only the license plate info is updated. For example, if license plate “5KZU734”changes to “6LTY496”, then aggregation of driving incident reports for this vehicle at operation 62 may include reports for “5KZU734” and the new “6LTY496”. This type of aggregation may be valuable for services such as CARFAX or Experian AutoCheck which track vehicle title and maintenance records

To aggregate driving incident reports for a common driver, operation 62 may take into account changes in ownership or control (e.g., a car given from parent to dependent to use). If vehicle ownership and/or control changes, then aggregation for a common driver at operation 62 may take this change into account. For example, all driving incident reports up to the date of the ownership and/or control change may be correlated to the previous owner/operator, while driving incident reports after the date of ownership and/or control change may be correlated to the new owner/operator for aggregation at operation 62. This process may provide value in assessing driving performance of individual drivers.

Aggregating the driving incident reports may include generating an aggregated report. The aggregated report may include, for example, an aggregation metric, a listing or representation of the individual driving incident reports aggregated at operation 62, and/or other information. The aggregation metric may represent a safety level. For aggregation on an individual vehicle, the aggregation metric may represent the manner in which the vehicle has been operated. For aggregation on an individual driver, the aggregation metric may represent a driving score. The aggregation metric may be determined by aggregating (e.g., through addition, averaging, and/or other aggregation techniques) the weights determined at operation 64 for the aggregated driving incident reports.

At an operation 68, the aggregation report may be presented. This may include transmitting the aggregation report to a computing platform associated with a user, presenting the aggregation report to a user via an electronic display or a paper print out, and/or presenting the aggregation report in other ways. The aggregation report for an individual driver or household, for example, may facilitate risk analysis on a driver or household for insurance underwriting purposes. The aggregation report for an individual vehicle may provide insight to a perspective purchaser of the vehicle. Other uses are contemplated for such aggregation reports.

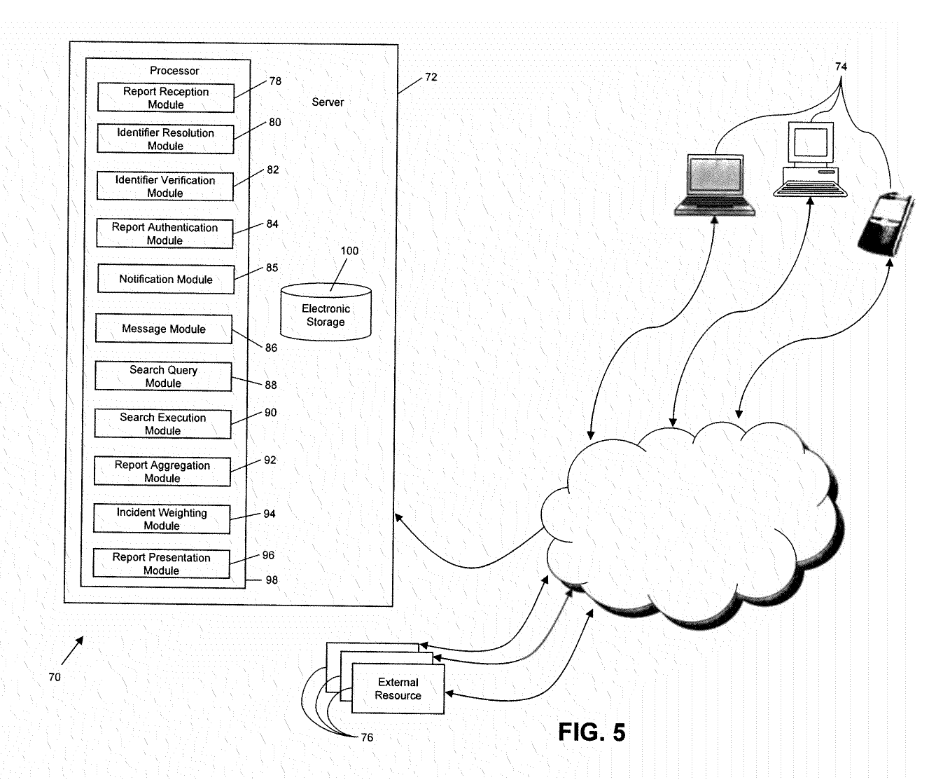

FIG. 5 illustrates a system 70 configured to organize information related to vehicle operation. This may include acceptance, verification, authentication, aggregation, and/or other functionality with respect to driving incident reports received from users. The driving incident reports may report individual driving incidents. System 70 may provide a medium through which individuals may report on the operation of individual vehicles, the performance of individual drivers, transmit messages to each other, and/or perform other tasks. The system may include one or more servers 72, client computing platforms 74, external resources 76, and/or other components. The server 72 may be configured to communicate with the one or more client computing platforms 74 according to a client/server architecture. The users may access system 70 via client computing platforms 74.

The server 72 may be configured to execute one or more computer program modules. The computer program modules may include one or more of a report reception module 78, an identifier resolution module 80, an identifier verification module 82, a report authentication module 84, a notification module 85, a message module 86, a search query module 88, a search execution module 90, a report aggregation module 92, an incident weighting module 94, a report presentation module 96, and/or other modules.

The report reception module 78 may be configured to receive driving incident reports. The driving incident report may be generated and/or transmitted by user via client computing platforms 74. In some implementations, report reception module 78 may be configured to receive a transmission of an driving incident report that is similar to or the same as the transmission made at operation 14 (shown in FIG. 1 and described above).

The identifier resolution module 80 may be configured to resolve a vehicle identifier included in a received driving incident report. This may include resolving audio information, video information, still image information, handwriting information, and/or other information into text or plain text. In some implementations, identifier resolution module 80 may be configured to perform one or more operations similar to or the same as operations 16 and/or 20 (shown in FIG. 1 and described above).

The identifier verification module 82 may be configured to verify resolutions of vehicle identifiers made by identifier resolution module 80. This may include verifying such resolutions based on a comparison of stated vehicle description information with stored vehicle description information (e.g., from a DMV database), verifying such resolutions based on user responses, and/or other verification techniques. In some implementations, identifier verification module 82 may be configured to perform one or more operations similar to or the same as operations 18, 22, 24, and/or 26 (shown in FIG. 1 and described above).

The report authentication module 84 may be configured to authenticate received driving incident reports. Such authentication may be based on time information, location information, reporting user information, vehicle identifier information, and/or other information. In some implementations, report authentication module 84 may be configured to perform one or more operations similar to or the same as 32, 34, and/or 36 (shown in FIG. 2 and described above).

The notification module 85 may be configured to generate notifications of driving incident report based on notification rules. A notification rule may include one or more rule parameters, a notification recipient, a notification mechanism, and/or other aspects. Responsive to a driving incident report satisfying the rule parameters of a notification rule, notification module 85 may be configured to generate a notification to the notification recipient of the notification rule. In some implementations, notification module 85 may be configured to perform one or more operations similar to or the same as 38 and/or 40 (shown in FIG. 2 and described above).

The message module 86 may be configured to provide a medium through which users of system 70 may communicate. For example, message module 86 may be configured to deliver messages included in driving incident reports to users associated with the vehicle identifiers in the driving incident reports. An reporting user may leave a message (audio, text or any other form of multimedia) to the driver of the subject vehicle. The recipient (or subject vehicle's operator/owner) may respond and, as such, a two-way dialogue between both drivers (whether real-time or asynchronous) may established. Since flirting in the car is common, this may allow drivers for a first time ever to effectively connect with each other.

The search query module 88 may be configured to obtain a search query. The search query may include search parameters to be satisfied by stored driving incident reports. In some implementations, search query module 88 may be configured to perform one or more operations similar to or the same as 52 (shown in FIG. 3 and described above).

The search execution module 90 may be configured to execute search queries obtained by search query module 88. This may include retrieving any driving incident reports that match an obtained search query. The search execution module 90 may be configured to present search results obtained by executing the search query. In some implementations, search execution module 90 may be configured to perform one or more operations similar to or the same as 54 and/or 56 (shown in FIG. 3 and described above).

The report aggregation module 92 may be configured to aggregate driving incident reports. These aggregations may be based on vehicle identifiers (and/or information derived therefrom) included in the driving incident reports. For example, driving incident reports may be aggregated on a common vehicle, on a common operator or owner, and/or on other characteristics. The report aggregation module 92 may be configured to generate aggregate reports from such aggregations. An aggregate report may include a listing or representation of the individual driving incident reports in a report, an aggregation metric, and/or other information. In some implementations, report aggregation module 92 may be configured to perform one or more operations similar to or the same as 62 and/or 66 (shown in FIG. 4 and described above).

The incident weighting module 94 may be configured to weight individual driving incident reports. Such weighting may be based on timeliness, a reporting user, location information, incident type, and/or other information. The aggregated reports generated by report aggregation module 92 may be based on the weightings determined by incident weighting module 94 (e.g., the aggregated metric, and/or other aspects of the reports). In some implementations, incident weighting module 94 may be configured to perform one or more operations similar to or the same as 64 (shown in FIG. 4 and described above).

The report presentation module 96 may be configured to present aggregated reports. Such presentation may include transmission and/or presentation to users. In some implementations, report presentation module 96 may be configured to perform one or more operations similar to or the same as operation 68 (shown in FIG. 4 and described above).

In some implementations, the server 72, client computing platforms 74, and/or external resources 76 may be operatively linked via one or more electronic communication links. For example, such electronic communication links may be established, at least in part, via a network such as the Internet and/or other networks. It will be appreciated that this is not intended to be limiting, and that the scope of this disclosure includes implementations in which servers 72, client computing platforms 74, and/or external resources 76 may be operatively linked via some other communication media.

A given client computing platform 74 may include one or more processors configured to execute computer program modules. The computer program modules may be configured to enable an expert or user associated with the given client computing platform 74 to interface with system 70 and/or external resources 76, and/or provide other functionality attributed herein to client computing platforms 74. By way of non-limiting example, the given client computing platform 74 may include one or more of a desktop computer, a laptop computer, a handheld computer, a NetBook, a Smartphone, a computing platform integrated with a vehicle, and/or other computing platforms.

The external resources 76 may include sources of information, hosts and/or providers of virtual environments outside of system 70, external entities participating with system 70, and/or other resources. In some implementations, some or all of the functionality attributed herein to external resources 76 may be provided by resources included in system 70.

The server 72 may include electronic storage 98, one or more processors 100, and/or other components. The server 72 may include communication lines, or ports to enable the exchange of information with a network and/or other computing platforms. Illustration of server 72 in FIG. 5 is not intended to be limiting. The server 72 may include a plurality of hardware, software, and/or firmware components operating together to provide the functionality attributed herein to server 72. For example, server 72 may be implemented by a cloud of computing platforms operating together as server 72.

Electronic storage 98 may comprise electronic storage media that electronically stores information. The electronic storage media of electronic storage 98 may include one or both of system storage that is provided integrally (i.e., substantially non-removable) with server 72 and/or removable storage that is removably connectable to server 72 via, for example, a port (e.g., a USB port, a firewire port, etc.) or a drive (e.g., a disk drive, etc.). Electronic storage 98 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. The electronic storage 98 may include one or more virtual storage resources (e.g., cloud storage, a virtual private network, and/or other virtual storage resources). Electronic storage 98 may store software algorithms, information determined by processor 100, information received from server 72, information received from client computing platforms 74, and/or other information that enables server 72 to function as described herein.

Processor(s) 700 is configured to provide information processing capabilities in server 72. As such, processor 100 may include one or more of a digital processor, an analog processor, a digital circuit designed to process information, an analog circuit designed to process information, a state machine, and/or other mechanisms for electronically processing information. Although processor 100 is shown in FIG. 5 as a single entity, this is for illustrative purposes only. In some implementations, processor 100 may include a plurality of processing units. These processing units may be physically located within the same device, or processor 100 may represent processing functionality of a plurality of devices operating in coordination. The processor 100 may be configured to execute modules 78, 80, 82, 84, 85, 86, 88, 90, 92, 94, and/or 96. Processor 100 may be configured to execute modules 78, 80, 82, 84, 85, 86, 88, 90, 92, 94, and/or 96 by software; hardware; firmware; some combination of software, hardware, and/or firmware; and/or other mechanisms for configuring processing capabilities on processor 100.

It should be appreciated that although modules 78, 80, 82, 84, 85, 86, 88, 90, 92, 94, and/or 96 are illustrated in FIG. 5 as being co-located within a single processing unit, in implementations in which processor 100 includes multiple processing units, one or more of modules 78, 80, 82, 84, 85, 86, 88, 90, 92, 94, and/or 96 may be located remotely from the other modules. The description of the functionality provided by the different modules 78, 80, 82, 84, 85, 86, 88, 90, 92, 94, and/or 96 described below is for illustrative purposes, and is not intended to be limiting, as any of modules 78, 80, 82, 84, 85, 86, 88, 90, 92, 94, and/or 96 may provide more or less functionality than is described. For example, one or more of modules 78, 80, 82, 84, 85, 86, 88, 90, 92, 94, and/or 96 may be eliminated, and some or all of its functionality may be provided by other ones of modules 78, 80, 82, 84, 85, 86, 88, 90, 92, 94, and/or 96. As another example, processor 100 may be configured to execute one or more additional modules that may perform some or all of the functionality attributed below to one of modules 78, 80, 82, 84, 85, 86, 88, 90, 92, 94, and/or 96.

The illustration in FIG. 5 and description herein of the client/server architecture of system 70 is not intended to be limiting. In some implementations, the electronic game described herein may be provided to a user using a peer-to-peer architecture, on a single computing platform, and/or via other configuration. For example, in a single computing platform configuration, some or all of the functionality attributed herein to modules 78, 80, 82, 84, 85, 86, 88, 90, 92, 94, and/or 96 may be provided by one or more computer program modules being executed on one or more processors of an individual computing platform. This may include, for example, a computing platform similar to or the same as client computing platforms 74.

Although the system(s) and/or method(s) of this disclosure have been described in detail for the purpose of illustration based on what is currently considered to be the most practical and preferred implementations, it is to be understood that such detail is solely for that purpose and that the disclosure is not limited to the disclosed implementations, but, on the contrary, is intended to cover modifications and equivalent arrangements that are within the spirit and scope of the appended claims. For example, it is to be understood that the present disclosure contemplates that, to the extent possible, one or more features of any implementation can be combined with one or more features of any other implementation.

What is claimed is:

1. A system configured to organize information related to operation of vehicles, the system comprising:
one or more processors configured to execute computer program modules, the computer program modules comprising:
a report reception module configured to receive driving incident reports generated and transmitted by users via computing platforms associated with the users, wherein an individual driving incident report includes a vehicle identifier of a subject vehicle and a reporting identifier of a reporting user;
a report aggregation module configured to aggregate driving incident reports based on the vehicle identifiers included in the incident reports to generate aggregated reports; and
a report presentation module configured to present aggregated reports.

2. The system of claim 1, wherein the report aggregation module is configured such that responsive to a vehicle identifier for a specific vehicle having changed from a first vehicle identifier to a second vehicle identifier, the aggregated report for the specific vehicle includes driving incident reports including the first vehicle identifier and the second vehicle identifier.

3. The system of claim 1, wherein the driving incident reports include location information for one or both of the subject vehicle and/or the reporting user, and wherein the computer program modules further comprise a report verification module configured to verify driving incident reports based on the location information included therein.

4. The system of claim 3, wherein the report authentication module is configured to authenticate a driving incident report based on location information included in the driving incident report indicating the location of the subject vehicle and the location of the reporting user.

5. The system of claim 3, wherein the report authentication module is configured to authenticate a driving incident report associated with a specific subject vehicle based on location information included in one or more other driving incident reports associated with the specific subject vehicle.

6. The system of claim 1, wherein the report aggregation module is configured to such that the aggregation reports include an aggregation metric representing a safety of vehicle operation.

7. The system of claim 6, wherein the report aggregation module is configured to aggregate the driving incident reports such that an aggregation metric included in an aggregation report represents either a safety of operation of a specific vehicle or a safety of vehicle operation by a specific driver.

8. The system of claim 6, wherein the computer program modules further comprises an incident weighting module configured to weight individual driving incident reports based on one or more of timeliness, reporting user, location, or incident type.

9. The system of claim 1, wherein the computer program modules further comprise:
a search query module configured to obtain a search query; and
a search execution module configured to retrieve any driving incident reports matching the obtained search query.

10. The system of claim 9, wherein the search query module is configured to obtain search queries specifying one or more of a location, a vehicle identifier, a subject vehicle, a reporting user, a violation type, or an incident number threshold.

11. A method of organizing information related to operation of vehicles, the method comprising:
receiving driving incident reports generated and transmitted by users via computing platforms associated with the users, wherein an individual driving incident report includes a vehicle identifier of a subject vehicle and a reporting identifier of a reporting user;
aggregating driving incident reports based on the vehicle identifiers included in the incident reports to generate aggregated reports; and
presenting one or more aggregated reports.

12. The method of claim 11, wherein, responsive to a vehicle identifier for a specific vehicle having changed from a first vehicle identifier to a second vehicle identifier, the aggregated report for the specific vehicle is based on driving incident reports including the first vehicle identifier and the second vehicle identifier.

13. The method of claim 11, wherein the driving incident reports include location information for one or both of the subject vehicle and/or the reporting user, and wherein the method further comprises authenticating driving incident reports based on the location information included therein.

14. The method of claim 11, wherein at least one of the aggregation reports includes an aggregation metric representing a safety of vehicle operation.

15. The method of claim 1, further comprising:
receiving a search query; and
retrieving any driving incident reports matching the obtained search query.

16. A system configured to organize information related to operation of vehicles, the system comprising:
one or more processors configured to execute computer program modules, the computer program modules comprising:
a report reception module configured to receive driving incident reports generated and transmitted by users via computing platforms associated with the users, wherein an individual driving incident report includes a vehicle identifier of a subject vehicle and a reporting identifier of a reporting user; and
a notification module configured (i) to compare received driving incident reports to a set of one or more notification rules, wherein a given notification rule comprises one or more rule parameters and a report recipient, and (ii) to generate, responsive to the one or more rule parameters of the given notification rule being satisfied by a received driving incident report, a notification of the driving incident report to the report recipient of the given notification rule.

17. The system of claim 16, wherein satisfaction of the one or more rule parameters of the given notification rule requires the driving incident report to specify a specific vehicle identifier, a location within a specific geographical area, or a specific driving incident type.

18. The system of claim 16, wherein the notification module is configured to compare, responsive to a first notification rule requiring a plurality of driving incident reports to satisfy the rule parameters of the first notification rule, a plurality of received driving incident reports to the notification parameters of the first notification to determine whether the rule parameters of the first notification rule have been satisfied.

19. The system of claim 18, wherein the rule parameters of the first notification rule require for satisfaction a threshold number of driving incidents for an individual vehicle identifier within a threshold distance inside of a threshold time period.

20. The system of claim 16, wherein the vehicle identifiers include license plate numbers.
